(19) United States
(12) Patent Application Publication
(10) Pub. No.: US 2006/0045126 A1
(43) Pub. Date: Mar. 2, 2006

(54) Method and apparatus for adaptively selecting sampling frequency for analog-to-digital conversion

(75) Inventors: Gerard Klahn, Sayville, NY (US); Fryderyk Tyra, Huntington Station, NY (US); John W. Haim, Baldwin, NY (US); Tanbir Haque, Long Island City, NY (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: InterDigital Technology Corporation, Wilmington, DE (US)

(21) Appl. No.: 11/167,341

(22) Filed: Jun. 27, 2005

Related U.S. Application Data
(60) Provisional application No. 60/605,708, filed on Aug. 30, 2004.

(51) Int. Cl. H04J 3/16

(52) U.S. Cl. 370/465

(57) ABSTRACT

The present invention is related to a method and apparatus for adaptively selecting local oscillator (LO) and sampling frequencies for analog-to-digital conversion of a plurality of input signals for transmitting two or more services via two or more frequency bands. Each input signal carries a different service via a different frequency band. Each service is subject to a minimum signal-to-interference, noise and distortion ratio (SINAD) requirement. The input signals are converted to an intermediate frequency (IF) band signals by mixing the input signals with LO signals. The LO and sampling frequencies are adjusted such that the converted IF band signals of the input signals are spectrally adjacent or overlapping each other to some degree. SINAD of the services is measured at each of a plurality of spectrally overlapping conditions. The LO frequencies and the sampling frequency are then adjusted based on the SINAD measurement results.

### CROSS REFERENCE TO RELATED APPLICATION

This application claims the benefit of U.S. provisional application No. 60/605,708 filed Aug. 30, 2004, which is incorporated by reference as if fully set forth.

### FIELD OF INVENTION

The present invention is related to a wireless communication system. More particularly, the present invention is related to a method and apparatus for adaptively selecting sampling frequency for analog-to-digital conversion of a plurality of input signals for transmitting two or more services via two or more frequency bands.

### BACKGROUND

Typical single-mode cellular base stations and wireless transmit/receive units (WTRUs) include a heterodyne radio receiver analog front end, a fixed sampling rate analog-to-digital converter (ADC) and subsequent digital processing units. In the analog front end, the desired signal is filtered and then down-converted to a fixed intermediate frequency (IF) band. The ADC operates at a fixed sampling rate that is chosen a priori based on the bandwidth of the desired signal requirements of the demodulation algorithms of the digital process and other factors.

When the base station or WTRU is supporting multiple simultaneous services and/or channels at different carrier frequencies in a single radio receiver, the various services and/or channels are filtered and separately down-converted in the analog front end to IF and then separately converted to digital samples at fixed sampling rates.

The sampling rate of the ADC is one of the factors that affects the power consumption of the receiver. The power consumption of the ADC and other processing blocks in a modem is, in general, proportional to the sampling rate; higher sampling rates require more power than do lower sampling rates.

### SUMMARY

The present invention is related to a method and apparatus for a Software Defined Radio (SDR) using one ADC and adaptively selecting the sampling frequency for analog-to-digital conversion of a plurality of input signals comprising two or more services received in two or more different frequency bands and adaptively selecting the local oscillator (LO) frequencies. Each input signal carries a different service via a different frequency band. The input signals are received simultaneously. Each service is subject to a minimum signal-to-noise and distortion ratio (SINAD) requirement. The input signals are converted to IF band signals by mixing the input signals with multiple LO signals at certain frequencies. The LO frequencies are adaptively selected such that the IF bands are spectrally adjacent or overlapping to each other to some degree. The SINAD of the services is measured at each of a plurality of spectrally overlapping conditions. The LO frequencies and the sampling frequency are then adjusted based on the SINAD measurement results. The process is preferably continually repeated.

### BRIEF DESCRIPTION OF THE DRAWINGS

A more detailed understanding of the invention may be had from the following description of a preferred embodiment, given by way of example and to be understood in conjunction with the accompanying drawing wherein:

FIG. 1 is a block diagram of a receiver for adaptively selecting the sampling frequency for analog-to-digital conversion of two input signals in accordance with the present invention;

FIGS. 2A-2F are block diagrams illustrating frequency translation of RF bands to the final IF frequencies in accordance with the present invention; and

FIG. 3 is a flow diagram of a process for adaptively selecting the sampling frequency for analog-to-digital conversion of a plurality of input signals in a receiver in accordance with the present invention.

### DETAILED DESCRIPTION OF THE PREFERRED EMBODIMENTS

Hereafter, the terminology “WTRU” includes but is not limited to a user equipment, a mobile station, a fixed or mobile subscriber unit, a pager, or any other type of device capable of operating in a wireless environment. When referred to hereafter, the terminology “base station” includes but is not limited to a Node-B, a site controller, an access point or any other type of interfacing device in a wireless environment.

The features of the present invention may be incorporated into an integrated circuit (IC) or be configured in a circuit comprising a multitude of interconnecting components.

The present invention can be implemented both in a base station and a WTRU. In accordance with the present invention, the SDR simultaneously receives two or more services and/or channels by utilizing two or more summed local oscillators to independently control the final IF frequencies of the two or more services and/or channels and to adaptively select the two or more local oscillator frequencies and sampling frequency. The SDR in accordance with the present invention adaptively minimizes the sampling frequency and thus reduces the power consumption of the ADC and the processing blocks in the modem and increases overall battery life.

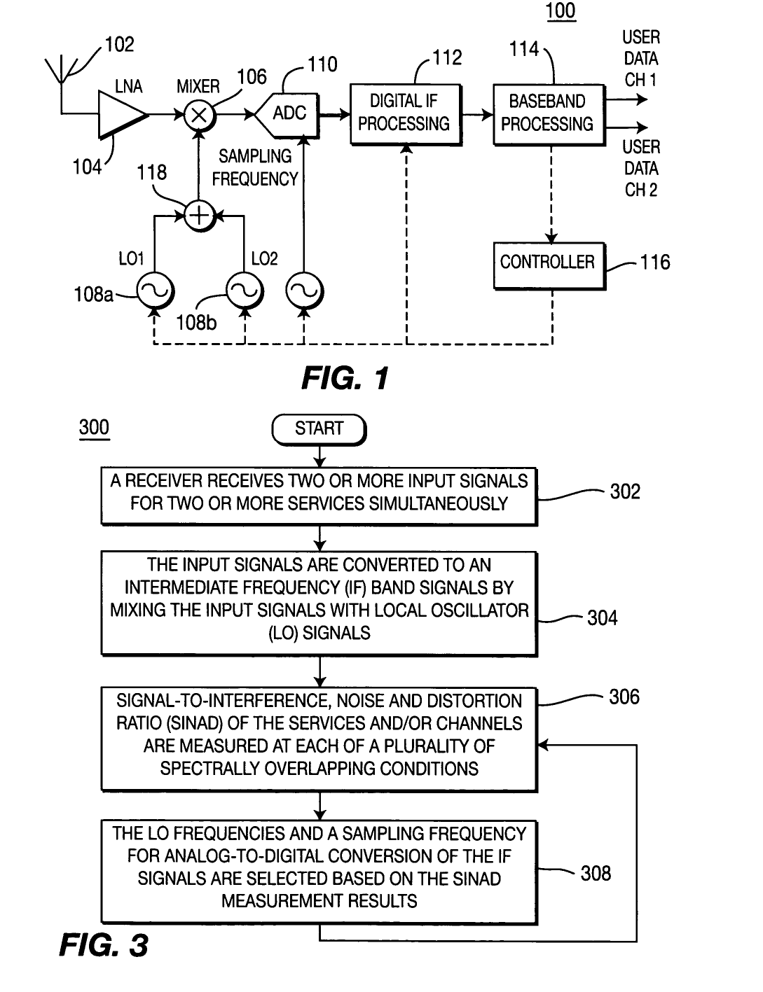

FIG. 1 is a block diagram of a receiver 100 for adaptively selecting LO frequencies and a sampling frequency for analog-to-digital conversion of a plurality of simultaneously received input signals in accordance with the present invention. The receiver 100 comprises an antenna 102, a low noise amplifier (LNA) 104, a mixer 106, two local oscillators (LOs) 108a and 108b, a summer 118, an ADC 110, a digital IF processing unit 112, a baseband processing unit 114, and a controller 116. Two or more input signals are detected simultaneously by the antenna 102 for two or more services and/or channels. Each service and/or channel is transmitted via a different carrier frequency band and is subject to a unique signal-to-interference, noise and distortion ratio (SINAD) requirement. The LNA 104 amplifies the received input signals.

Each LO 108a, 108b generates a LO signal of a corresponding frequency for each service and/or channel. FIG. 1 illustrates only two LOs as an example, but more than two LOs can be used to place the downlink bands of multiple services and/or channels anywhere within the final IF bandwidth. The frequencies of the LO signals are controlled by the controller 116. The LO signals are summed together by the summer 118 and forwarded to the mixer 106.

The mixer 106 mixes the input signals with LO signals to convert each RF input signal to an IF signal. Only one stage of mixing is illustrated in FIG. 1. However, it should be noted that more than one stage of mixing may be implemented to convert each RF signal to a final IF signal. The final IF bands are selected such that the IF bands of the services and/or channels spectrally adjacent or overlap each other to some degree. The spectral overlap may result in interference within the receiver to one or both of the bands and/or channels.

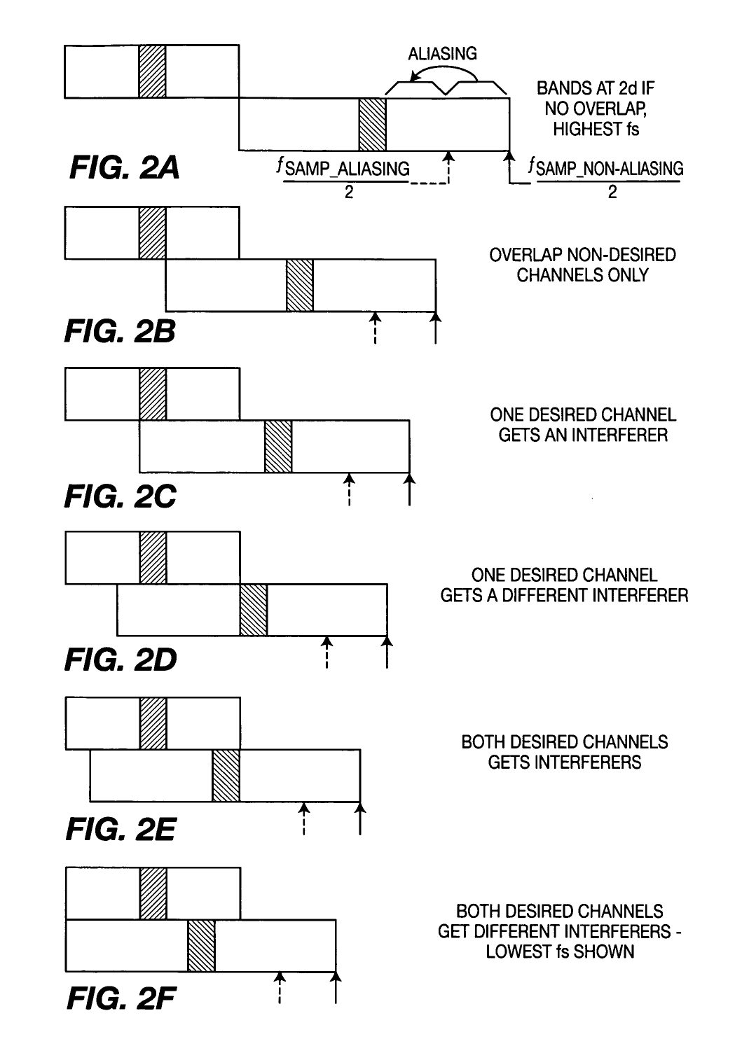

FIGS. 2A-2F are block diagrams of IF spectra illustrating frequency translation of RF input signals to final IF bands in accordance with the present invention. The shaded region in FIGS. 2A-2F represents the frequency channel of interest.

The LO frequencies are adjusted so that the down-conversion causes the input signals to be converted in the final IF bands adjacent or overlapping each other to some degree as shown in FIGS. 2A-2F. In FIG. 2A, the IF bands for the services are adjacent and do not overlap each other. Therefore, no interference is caused by one band to the other. In FIG. 2B, the two IF bands overlap each other only in the non-interested frequency channels. In FIGS. 2C and 2D, one desired channel gets an interferer and in FIGS. 2E and 2F, both desired channels get interferers. In FIG. 2F, the entire IF band of one service and/or channel is overlapped to the other IF band.

In order to avoid aliasing of any region of the IF bands, the sampling frequency should be set to a value at least twice higher than the highest frequency component of the highest IF band. The sampling frequency can be lower than that value, in that aliasing of a region of an IF band not within a channel of interest is acceptable. Therefore, the sampling frequency is determined by the service and/or channel having the highest frequency component among a plurality of services and/or channels processed simultaneously. A half of the minimum sampling frequency for avoiding aliasing in a channel of interest is indicated by the solid arrow in FIGS. 2A-2F. A half of the minimum required sampling frequency for avoiding aliasing in the frequency band in interest is indicated by the dashed arrow in FIGS. 2A-2F. The sampling frequency can be even lower than that shown by the dashed arrow, if SINAD degradation due to the aliasing of the upper frequency components into the channel of interest is tolerable.

As the degree of overlapping increases from FIG. 2A to FIG. 2F, the sampling frequency decreases but the interference in the channels of interest increases. Therefore, the overlapping condition and sampling frequency should be selected considering both the sampling frequency and the interference.

The selected IF bandwidth and the overlapping condition at the final IF band is adaptively adjusted as a function of the measured SINAD of the simultaneous services and/or channels of interest. Each service and/or channel has a minimum SINAD criterion that must be satisfied. Referring back to FIG. 1, the baseband processing unit 114 measures SINADs at various overlap conditions and the controller 116 selects the overlap condition with the lowest sampling frequency satisfying the minimum SINAD criteria as the optimal sampling frequency.

The ADC 110 converts the IF band signals to digital signals at the sampling frequency set by the controller 116. The digital IF processing unit 112 and the baseband processing unit 114 process the digital signals for the services. The digital IF processing unit 112 performs final frequency conversion from IF to base band. The digital IF processing unit 112 separates the services from each other.

By adaptively controlling the final IF bands of the services and/or channels, the sampling frequency can be adaptively minimized. Minimizing the sampling frequency reduces the power consumption of the ADC and the processing blocks in the modem and increases overall battery life.

Channel conditions, (such as distance from cells, changes in adjacent channels, etc.), changes over time. The selection of the overlap condition and the optimal sampling frequency is re-evaluated at some rate. Because the presence or absence of adjacent channels is unknown to the WTRU and can change at a rate faster than that anticipated for the above described re-evaluation, in order to prevent unacceptable sudden degradation of connections, the evaluation of the spectral overlapping and selection of the optimal sampling frequency can be confined to non-connected or idle periods, or periods in which only packet data is received. During periods in which sudden degradation is not acceptable, the receiver operates without spectral overlap at the highest sampling frequency supporting this condition.

Regardless of the selection of the overlap condition and optimal sampling frequency, the sampling frequency can be further reduced by deliberately introducing aliasing in the frequency band which is not in interest.

FIG. 3 is a flow diagram of a process 300 for adaptively selecting the sampling frequency for analog-to-digital conversion of a plurality of input signals in a receiver in accordance with the present invention. A receiver receives two or more input signals for two or more services and/or channels simultaneously (step 302). Each service and/or channel is subject to a minimum SINAD requirement. The input signals are converted to IF band signals by mixing the input signals with LO signals (step 304). The LO frequencies are adjusted such that the converted IF band signals of the input signals are spectrally adjacent or overlapping each other to some degree. The SINAD of the services and/or channels are measured at each of a plurality of spectrally overlapping conditions (step 306). The LO frequencies and the sampling frequency for analog-to-digital conversion of the IF signals are selected based on the SINAD measurement results (step 308). The steps 306 and 308 are preferably repeated, periodically or non-periodically.

Although the features and elements of the present invention are described in the preferred embodiments in particular combinations, each feature or element can be used alone without the other features and elements of the preferred embodiments or in various combinations with or without other features and elements of the present invention.

What is claimed is:

1. A method for adaptively selecting a sampling frequency for analog-to-digital conversion of a plurality of input signals in a receiver, each input signal carrying a different service via a different frequency band, the method comprising:
(a) simultaneously receiving at least two input signals for at least two services, each service being subject to a minimum signal-to-interference, noise and distortion ratio (SINAD) requirement;
(b) converting the input signals to intermediate frequency (IF) band signals by mixing the input signals with local oscillator (LO) signals, said LO frequencies being adjusted such that the converted IF band signals of the input signals are at least spectrally adjacent each other;
(c) measuring said SINAD of the services at each of a plurality of spectrally overlapping conditions; and
(d) selecting the LO frequencies and a sampling frequency for analog-to-digital conversion of the IF signals based on the SINAD measurement results.

2. The method of claim 1 wherein said converted IF band signals are overlapping.

3. The method of claim 2 wherein the sampling frequency is selected to a minimum value for overlapping IF band signals that satisfy the minimum SINAD requirements for the services.

4. The method of claim 1 wherein the steps (a)-(d) are repeated for reevaluating the selected sampling frequency and the LO frequencies.

5. The method of claim 4 wherein the reevaluation of the selected sampling frequency and the LO frequencies is performed periodically.

6. The method of claim 1 wherein the sampling frequency and the LO frequencies are selected such that no aliasing is introduced.

7. The method of claim 1 wherein the sampling frequency and the LO frequencies are selected to introduce aliasing in a portion of a frequency band not in interest, whereby the sampling frequency is reduced.

8. The method of claim 1 wherein the receiver is configurable by software.

9. A receiver for adaptively selecting local oscillator (LO) frequencies and a sampling frequency for analog-to-digital conversion of a plurality of input signals, each input signal carrying a different service via a different frequency band, the receiver comprising:
an antenna for receiving a plurality of input signals for the services simultaneously, each service being subject to a minimum signal-to-interference, noise and distortion ratio (SINAD) requirement;
a plurality of LOs for generating LO frequency signals;
a mixer for mixing the input signals to the LO signals to generate an intermediate frequency (IF) band signals, said LO frequencies being adjusted such that the converted IF band signals of the input signals are at least spectrally adjacent each other;
an analog-to-digital converter (ADC) for generating digital signals by sampling the IF band signals at the sampling frequency;
a baseband processor for measuring said SINAD of the services at each of a plurality of spectrally overlapping conditions; and
a controller for adjusting the LO frequency and the sampling frequency based on the SINAD measurement results.

10. The receiver of claim 9 wherein said converted IF band signals are overlapping.

11. The receiver of claim 10 wherein the sampling frequency is selected to a minimum value for overlapping IF band signals that satisfy the minimum SINAD requirements for the services.

12. The receiver of claim 9 wherein the controller subsequently reevaluates the selected sampling frequency and the LO frequencies.

13. The receiver of claim 12 wherein the reevaluation of the selected sampling frequency and the LO frequencies is performed periodically.

14. The receiver of claim 9 wherein the sampling frequency and the LO frequencies are selected such that no aliasing is introduced.

15. The receiver of claim 9 wherein the sampling frequency and the LO frequencies are selected to introduce aliasing in a frequency band not in interest, whereby the sampling frequency is reduced.

16. The receiver of claim 9 wherein the receiver is configurable by software.
